(19) United States
(12) Patent Application Publication
(10) Pub. No.: US 2016/0240278 A1
(43) Pub. Date: Aug. 18, 2016

(54) CONDUCTIVE FILM AND METHOD OF MANUFACTURING THE SAME

(71) Applicant: SHENZHEN CHINA STAR OPTOELECTRONICS TECHNOLOGY CO., LTD., Shenzhen, Guangdong (CN)

(72) Inventors: Yungjui LEE, Shenzhen, Guangdong (CN); Ji LI, Shenzhen, Guangdong (CN); Yahui CHEN, Shenzhen, Guangdong (CN)

(73) Assignee: Shenzhen China Star OPtoelectronics Technology Co., Ltd., Shenzhen, Guangdong (CN)

(21) Appl. No.: 14/384,667

(22) PCT Filed: Aug. 14, 2014
(86) PCT No.: PCT/CN2014/084337

§ 371 Date: Sep. 11, 2014

(30) Foreign Application Priority Data
Jul. 17, 2014 (CN) 201410342458.5

(51) Int. Cl. H01B 1/24

(52) U.S. Cl. CPC H01B 1/24

(57) ABSTRACT

The present invention provides a method of manufacturing conductive film and the conductive film itself. The method of manufacturing conductive film comprises the following steps: step 1 for preparing a graphene oxide; step 2 for providing a functional reagent to reacting with the graphene oxide for producing a functionalized graphene; step 3 for providing a curing agent and an organic solvent to mix with a certain amount of conductive particles, and then processed by an ultrasonic to produce a conductive particle dispersion liquid; the conductive particles are the functionalized graphene or a mixture of the functionalized graphene and other conductive particle; step 4 for providing an adhesive resin and diluting the adhesive resin with the organic solvent in the step 3; step 5 for mixing the adhesive resin diluted in the step 4 and the conductive particle dispersion liquid to produce a conductive film pre-mixture, and the conductive film pre-mixture is stirred repeatedly to be well mixed, and, after dispersed by the ultrasonic, the organic solvent is removed to produce a conductive film.

### FIELD OF THE INVENTION

The present invention relates to the technical field of liquid crystal display, and more particularly to a method of manufacturing a conductive film and the conductive film itself.

### BACKGROUND OF THE INVENTION

Nowadays, a conductive film is mainly comprised of a polymer adhesive substrate and metal conductive filler for combining the conductive particles together by adhesive effect of the resin substrate to form a conductive path and realize a conductive connection between the adhered materials. The conductive particles used in the conductive film are usually metal powders of Au, Ag, Al, Cu, Ni, etc. Cu, Al and Ni are cheap and with good conductivity, however, they are easily to be oxidized in the air when the temperature is high such that the conductivity becomes poor and the stability and reliability is limited. The powder of Ag has good conductivity and chemical stability, and is hardly to be oxidized in the adhesive substrate, however, the density is relatively big, precipitation occurs easily, and electromigration moving out occurs under moisture circumstance. In order to solve the above mentioned problems, a surface of plastic particle, on which is plated by metal Ni, is further plated by Au to form a conductive golden ball for performing the conductive connection. However, the golden ball has the following defects: (1) the interface force between the plastic layer and the metal layer is poor so that the conductivity and mechanical performance becomes bad after a long term usage; (2) the electroplating process performed during the manufacturing procedure makes serious environment pollution; (3) Au is an expensive and rare metal.

Graphene is a carbon-nanomaterial having outstanding electrical and thermal conductivity. Once the graphene is used as the conductive filler in the conductive film, an outstanding conductivity can be provided for the conductive film. Besides, compared to a conductive channel formed by point contacting between the sphericity conductive particles, the probability of forming a conductive channel by surface contacting between the graphene since the graphene has a sheet structure. The outstanding thermal conductivity of the graphene ensures the heat dissipation of the conductive film by uniformly distributing the graphene sheet layer in the conductive film. By using the outstanding thermal conductivity, it is beneficial to dissipating the heat generated by Ohm effect of the current in the real application in time by the conductive film such that the temperature of the conductive film can be lowered and the conductive film is prevented from being failed.

Graphene itself has outstanding mechanical strength and ductility. Therefore, the sheet structure and the ductility of graphene ensure the stability of adhesion and conductivity even a large force is applied to the location of adhesion when the conductive film is used for adhering to an object. Graphene can further enhance the adhesive substrate and improves the adhesion strength of the conductive film.

Nowadays, researches on using graphene as conductive fillers in the conductive film and other composite materials are widely reported. However, the key point of good performance of electrical conductivity of graphene is whether the graphene can be uniformly distributed in the polymer substrate or not. The polymer substrate usually used in the conductive film includes epoxy resin, polyacrylate resin, phenolic resin, polyurethane data, organosilicone resin, etc. Graphene cannot be distributed in the conductive substrate due to polar groups of the resins, lack of functional group on surface of graphene and, furthermore, extremely high specific surface area of graphene.

### SUMMARY OF THE INVENTION

One object of the present invention is to provide a method of manufacturing conductive film. By introducing functionalized molecular having polar groups onto the surface of the graphene, distribution of the functionalized graphene in the adhesive resin can be improved.

One object of the present invention is to further provide a conductive film. A part or all of the conductive particles are the functionalized graphene such that the conductive particles can be uniformly distributed in the produced conductive film, and the conductive film can have outstanding electrical conductivity, thermal conductivity and adhesion strength.

In order to achieve the above mentioned objects, the present invention provides a method of manufacturing conductive film, which comprises the following steps:

step 1: preparing a graphene oxide;

step 2: providing a functional reagent to reacting with the graphene oxide for producing a functionalized graphene;

step 3: providing a curing agent and an organic solvent to mix with a certain amount of conductive particles, and then processed by an ultrasonic to produce a conductive particle dispersion liquid; the conductive particles are the functionalized graphene or a mixture of the functionalized graphene and other conductive particle;

step 4: providing an adhesive resin and diluting the adhesive resin with the organic solvent in the step 3;

step 5: mixing the adhesive resin diluted in the step 4 and the conductive particle dispersion liquid to produce a conductive film pre-mixture, and the conductive film pre-mixture is stirred repeatedly to be well mixed, and, after dispersed by the ultrasonic, the organic solvent is removed to produce a conductive film.

The graphene oxide is prepared by Hummers method in the step 1; the organic solvent is removed by reduced pressure distillation in the step 5.

The functional reagent is γ-Aminopropyl triethoxysilane, γ-(2,3-epoxypropoxy) propyltrimethoxysilan, γ-Methacryloxypropyltrimethoxysilane, or N-(β-aminoethyl)-γ-aminopropylmethylbimethoxy silane.

The other conductive particle is nano-silver particle, micro-silver powder, polypyrrole particle or golden ball.

The curing agent is one or mixture of at least two of Methylhexahydrophthalic anhydride, phenyl-dimethylurea, triethylamine, 2-Ethyl-4-methylimidazole, 2-Ethyl-4-methyl-1H-imidazole-1-propanenitrile, 3-Aminopropyl-imidazole, or 1-Methylimidazole; and the organic solvent is one or mixed solvent of at least two of Acetonitrile, Acetone, Tetrahydrofuran, 1-Methyl-2-pyrrolidinone, water, Acetone, Ethanol, N,N-Dimethylformamide, dichloromethane, trichloromethane, propyl alcohol, isopropyl alcohol, or glycol.

The adhesive resin is epoxy resin, and the epoxy resin is one or mixture of at least two of Diglycidyl Ether of Bisphenol-A epoxy resin, bisphenol F epoxy resin, ethylene oxidic ester epoxy resin, aliphatic epoxy resin, or cycloaliphatic epoxy resin.

The present invention further provides a conductive film, which comprises a conductive particle, an adhesive resin and a curing agent; wherein the conductive particle is a functionalized graphene or a mixture of the functionalized graphene and other conductive particle; the other conductive particle is nano-silver particle, micro-silver powder, polypyrrole particle or golden ball.

A method of producing the functionalized graphene comprises: step 1 for preparing a graphene oxide; step 2 for providing a functional reagent to reacting with the graphene oxide for producing the functionalized graphene; wherein the functionalized reagent is γ-Aminopropyl triethoxysilane, γ-(2,3-epoxypropoxy) propyltrimethoxysilan, γ-Methacryloxypropyltrimethoxysilane, or N-(β-aminoethyl)-γ-aminopropylmethylbimethoxy silane.

The adhesive resin is epoxy resin, and the epoxy resin is one or mixture of at least two of Diglycidyl Ether of Bisphenol-A epoxy resin, bisphenol F epoxy resin, ethylene oxidic ester epoxy resin, aliphatic epoxy resin, or cycloaliphatic epoxy resin; the curing agent is one or mixture of at least two of Methylhexahydrophthalic anhydride, phenyl-dimethylurea, triethylamine, 2-Ethyl-4-methylimidazole, 2-Ethyl-4-methyl-1H-imidazole-1-propanenitrile, 3-Aminopropyl-imidazole, or 1-Methylimidazole.

The epoxy resin used in the conductive film has an amount of 20 wt %˜90 wt % of the conductive film, the functionalized graphene used in the conductive film has an amount of 1 wt %˜30 wt % of the conductive film, the other particle used in the conductive film has an amount of 0˜30 wt % of the conductive film, and the curing agent used in the conductive film has an amount of 0.1 wt %˜10 wt % of the conductive film.

The beneficial effect of the present invention is that by functionalizing the surface of the graphene, the obtained functionalized graphene can be uniformly distributed in the adhesive resin such that a better electrical conducting bridge capability can be obtained in the method of manufacturing the conductive film and the conductive film itself of the present invention. Compared to the conventional method of manufacturing conductive film, raw materials can be obtained more easily and economical, and is more environment friendly by using the functionalized graphene or mixture of the functionalized graphene and other conductive particles. Applying ultrasonic processing at the same time during the manufacturing procedure, the distribution and uniformity of the conductive particles can be improved and is beneficial on improving conductivity. In the conductive film of the present invention, a part or all of the conductive particles are the functionalized graphene such that the conductive particles can be uniformly distributed in the produced conductive film, and therefore the conductive film can have outstanding electrical conductivity, thermal conductivity and adhesion strength.

### BRIEF DESCRIPTION OF THE DRAWINGS

The technical solution and other beneficial effect can be easily known by describing the concrete embodiment in detail with the attached drawings as follows.

In the drawings:

FIG. 1 is a flow chart of the method of manufacturing conductive film of the present invention.

FIG. 2 is a schematic diagram showing reaction procedure of step 2 of the method of manufacturing conductive film of the present invention.

FIG. 3A is a photograph showing the dispersion liquid of the graphene oxide and the functionalized graphene.

FIG. 3B is an AFM photograph of the functionalized graphene.

FIG. 3C is an SEM photograph of the functionalized graphene.

FIG. 3D is a height diagram of the membrane of the functionalized graphene measured by AFM.

FIG. 4 is a structural schematic diagram of the conductive film according to one embodiment of the present invention.

FIG. 5 is a structural schematic diagram of the conductive film according to another embodiment of the present invention.

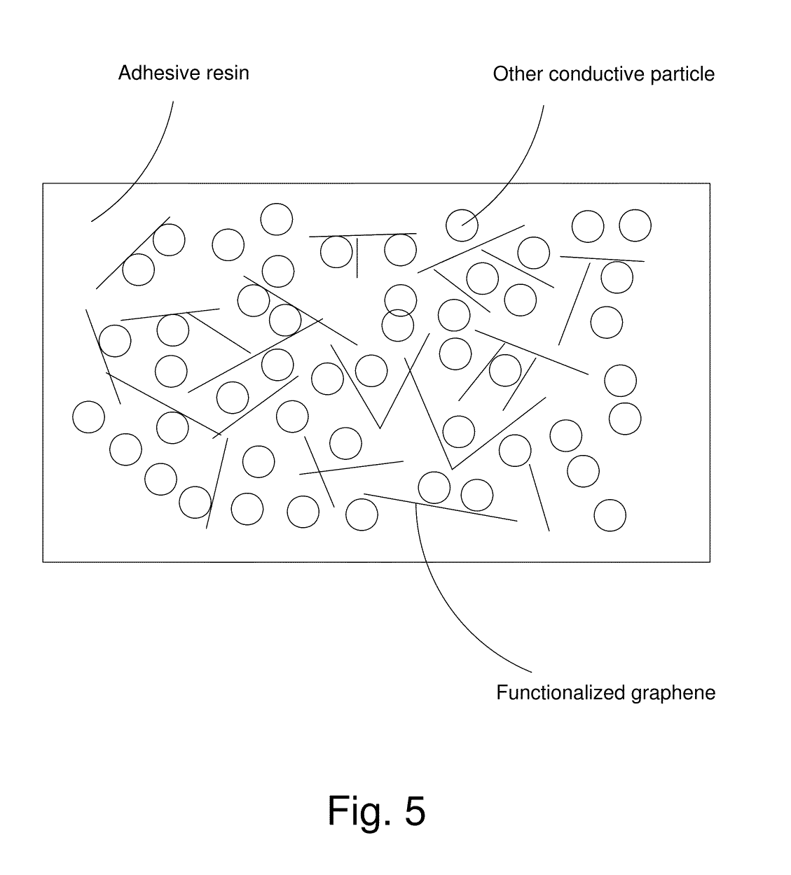

### DETAILED DESCRIPTION OF PREFERRED EMBODIMENTS

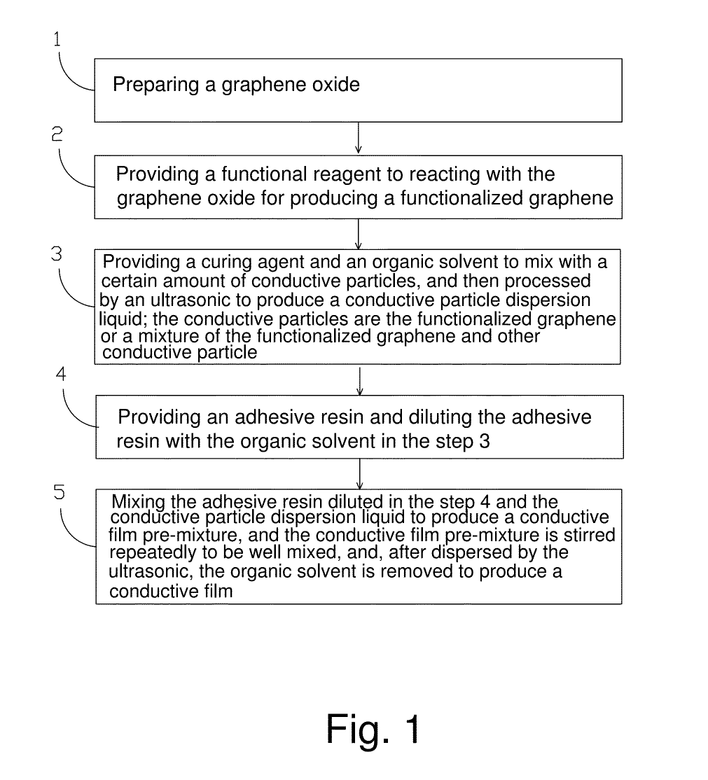

Please refer to FIG. 1. The present invention provides a method of manufacturing a conductive film, which comprises the steps as follows.

Step 1: preparing a graphene oxide; wherein the graphene oxide is prepared by Hummers method in the step 1.

Step 2: providing a functional reagent to reacting with the graphene oxide for producing a functionalized graphene.

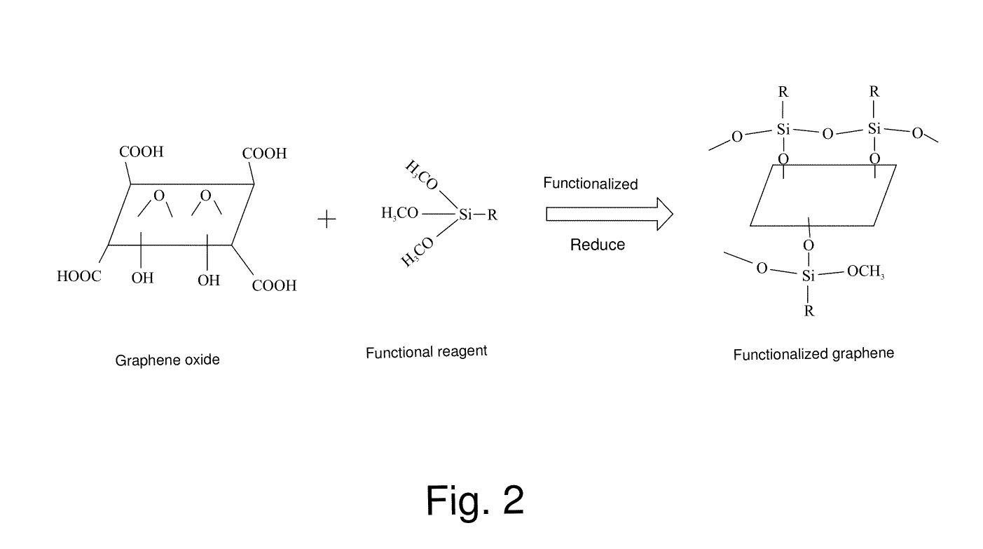

Please refer to FIG. 2. In the step 2, the functional reagent reacts with the functional groups on the surface of the graphene oxide to introduce the functionalized molecular onto the surface of the graphene oxide and reducing other oxygen functional groups on the surface of the graphene oxide to obtain the functionalized graphene. By introducing functionalized molecular having polar groups onto the surface of the functionalized graphene, distribution of the functionalized graphene in the adhesive resin can be improved.

A general structure of the functional reagent is:

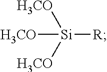

wherein the structure of the radical group R is

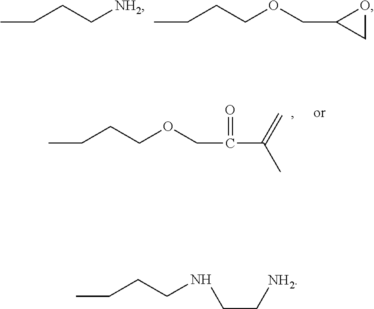

When the structure of the radical group R is

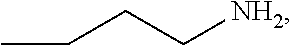

the functional reagent is γ-Aminopropyl triethoxysilane (KH-550).

When the structure of the radical group R is

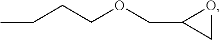

the functional reagent is γ-(2,3-epoxypropoxy) propyltrimethoxysilan (KH-560).

When the structure of the radical group R is

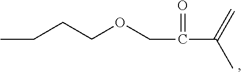

the functional reagent is γ-Methacryloxypropyltrimethoxysilane (KH-570).

When the structure of the radical group R is

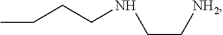

the functional reagent is N-(β-aminoethyl)-γ-aminopropylmethylbimethoxy silane (KH-602).

Step 3: providing a curing agent and an organic solvent to mix with a certain amount of conductive particles, and then processed by an ultrasonic to produce a conductive particle dispersion liquid.

Wherein, the conductive particles could be the functionalized graphene or a mixture of the functionalized graphene and other conductive particle.

The other conductive particle could be nano-silver particle, micro-silver powder, polypyrrole particle or golden ball.

When using the functionalized graphene with other conductive particle, not only the conductivity could be improved such that the conducting efficiency is increased, but also the amount of other conductive particle used therein could be decreased.

The curing agent could be one or mixture of at least two of Methylhexahydrophthalic anhydride, phenyl-dimethylurea, triethylamine, 2-Ethyl-4-methylimidazole, 2-Ethyl-4-methyl-1H-imidazole-1-propanenitrile, 3-Aminopropyl-imidazole, or 1-Methylimidazole.

The organic solvent could be one or mixed solvent of at least two of Acetonitrile, Acetone, Tetrahydrofuran, 1-Methyl-2-pyrrolidinone, water, Acetone, Ethanol, N,N-Dimethylformamide, dichloromethane, trichloromethane, propyl alcohol, isopropyl alcohol, or glycol.

The distribution and uniformity of the conductive particle can be improved by ultrasonic processing.

When the conductive particle is the functionalized graphene obtained by processing with γ-Aminopropyl triethoxysilane (KH-550), it is dispersed into the Tetrahydrofuran to obtain a conductive particle suspension.

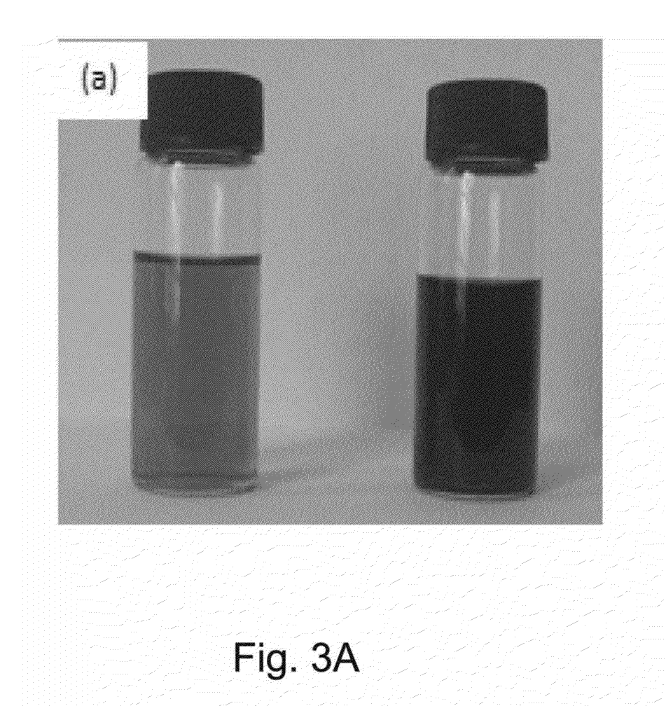

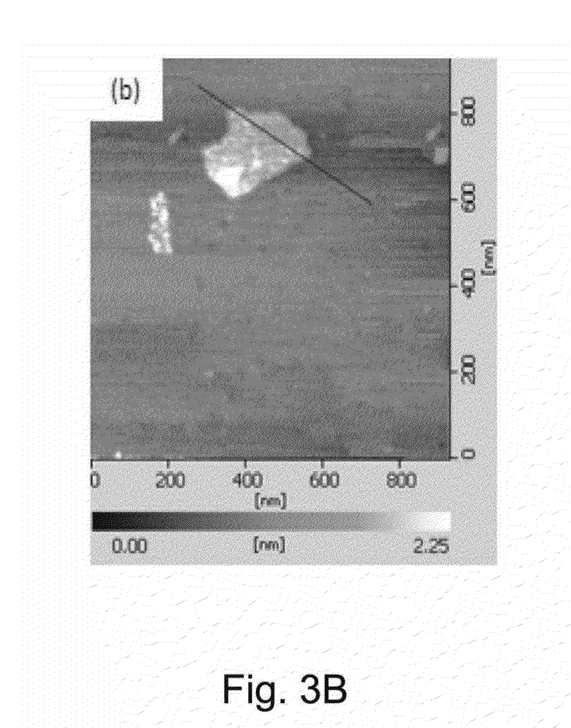

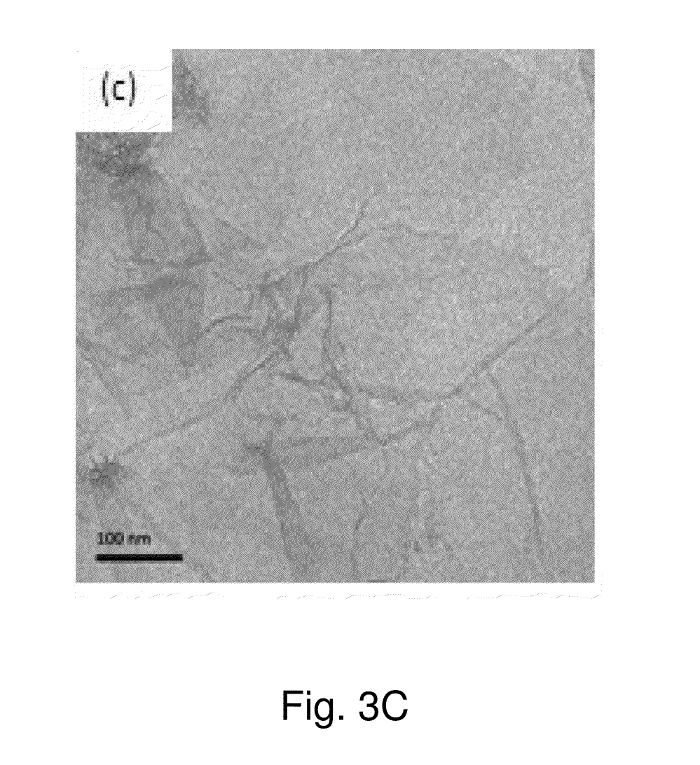

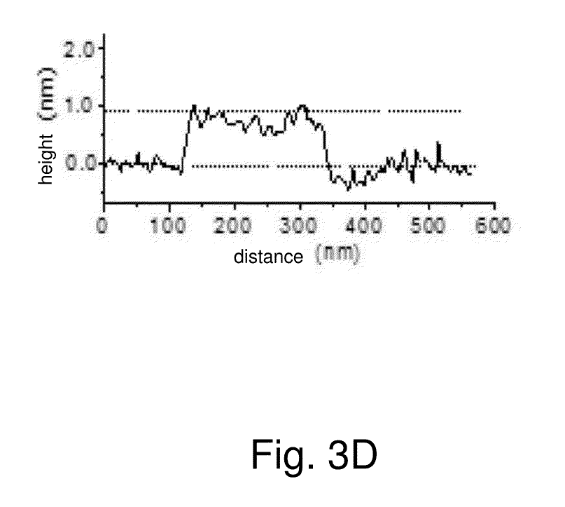

As shown in FIG. 3A, there are photographs of the dispersion liquid of graphene oxide (left) and KH-550 functionalized graphene (right).

As shown in FIG. 3B, there is the sheet structure of the KH-550 functionalized graphene.

As shown in FIG. 3C, it is noted that the KH-550 functionalized graphene has the same fold form as the graphene, and it is noted from the SEM (scanning electron microscope) diagram that no aggregate is formed by the functionalized graphene.

As shown in FIG. 3D, the depth of the KH-550 functionalized graphene measured by the AFM (atomic force microscope) is 1.0 nm and could be deemed as single layer dispersion.

It is noted in FIGS. 3A-3D that the dispersion liquid of the conductive particle is uniform and stable. The functionalized graphene can exist in the Tetrahydrofuran stably and dispersed in the form of single layer such that a great condition for uniformly dispersing the functionalized graphene in the adhesive resin is created accordingly.

Step 4: providing an adhesive resin and diluting the adhesive resin with the organic solvent in the step 3.

In the embodiment, the adhesive resin is epoxy resin, and the epoxy resin is one or mixture of at least two of Diglycidyl Ether of Bisphenol-A epoxy resin, bisphenol F epoxy resin, ethylene oxidic ester epoxy resin, aliphatic epoxy resin, or cycloaliphatic epoxy resin.

Step 5: mixing the adhesive resin diluted in the step 4 and the conductive particle dispersion liquid to produce a conductive film pre-mixture, and the conductive film pre-mixture is stirred repeatedly to be well mixed, and, after dispersed by the ultrasonic, the organic solvent is removed to produce a conductive film.

Wherein, the organic solvent is removed by reduced pressure distillation in the step 5.

The conductive particle is ensured to be dispersed uniformly in the entire mixture by further applying ultrasonic to disperse the conductive film pre-mixture.

The present invention further provides a conductive film, which comprises a conductive particle, an adhesive resin and a curing agent; wherein the conductive particle is a functionalized graphene or a mixture of the functionalized graphene and other conductive particle; the other conductive particle is nano-silver particle, micro-silver powder, polypyrrole particle or golden ball.

Wherein, the adhesive resin is epoxy resin, and the epoxy resin is one or mixture of at least two of Diglycidyl Ether of Bisphenol-A epoxy resin, bisphenol F epoxy resin, ethylene oxidic ester epoxy resin, aliphatic epoxy resin, or cycloaliphatic epoxy resin; the curing agent is one or mixture of at least two of Methylhexahydrophthalic anhydride, phenyl-dimethylurea, triethylamine, 2-Ethyl-4-methylimidazole, 2-Ethyl-4-methyl-1H-imidazole-1-propanenitrile, 3-Aminopropyl-imidazole, or 1-Methylimidazole.

The epoxy resin used in the conductive film has an amount of 20 wt %˜90 wt % of the conductive film, the functionalized graphene used in the conductive film has an amount of 1 wt %˜30 wt % of the conductive film, the other particle used in the conductive film has an amount of 0˜30 wt % of the conductive film, and the curing agent used in the conductive film has an amount of 0.1 wt %˜10 wt % of the conductive film.

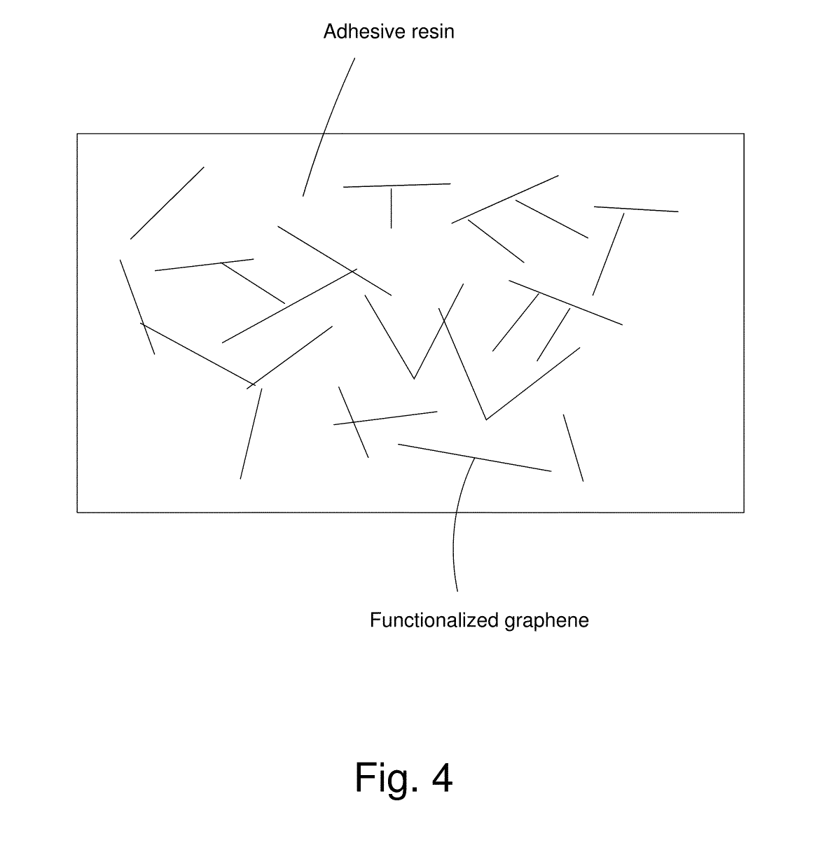

When the amount of other conductive particle is 0, i.e. the conductive particle is the functionalized graphene, the structure of the conductive film of the present invention is as the structure shown in FIG. 3. When the amount of other conductive particle is greater than 0, i.e. the conductive particle is the mixture of the functionalized graphene and other conductive particle, the structure of the conductive film of the present invention is as the structure shown in FIG. 4.

In summary, by functionalizing the surface of the graphene, the obtained functionalized graphene can be uniformly distributed in the adhesive resin such that a better electrical conducting bridge capability can be obtained in the method of manufacturing the conductive film and the conductive film itself of the present invention. Compared to the conventional method of manufacturing conductive film, raw materials can be obtained more easily and economical, and is more environment friendly by using the functionalized graphene or mixture of the functionalized graphene and other conductive particles. Applying ultrasonic processing at the same time during the manufacturing procedure, the distribution and uniformity of the conductive particles can be improved and is beneficial on improving conductivity. In the conductive film of the present invention, a part or all of the conductive particles are the functionalized graphene such that the conductive particles can be uniformly distributed in the produced conductive film, and therefore the conductive film can have outstanding electrical conductivity, thermal conductivity and adhesion strength.

What is claimed is:

1. A method of manufacturing conductive film, comprising the following steps:
step 1: preparing a graphene oxide;
step 2: providing a functional reagent to reacting with the graphene oxide for producing a functionalized graphene;
step 3: providing a curing agent and an organic solvent to mix with a certain amount of conductive particles, and then processed by an ultrasonic to produce a conductive particle dispersion liquid; the conductive particles are the functionalized graphene or a mixture of the functionalized graphene and other conductive particle;
step 4: providing an adhesive resin and diluting the adhesive resin with the organic solvent in the step 3;
step 5: mixing the adhesive resin diluted in the step 4 and the conductive particle dispersion liquid to produce a conductive film pre-mixture, and the conductive film pre-mixture is stirred repeatedly to be well mixed, and, after dispersed by the ultrasonic, the organic solvent is removed to produce a conductive film.

2. The method of manufacturing conductive film according to claim 1, wherein the graphene oxide is prepared by Hummers method in the step 1; the organic solvent is removed by reduced pressure distillation in the step 5.

3. The method of manufacturing conductive film according to claim 1, wherein the functional reagent is γ-Aminopropyl triethoxysilane, γ-(2,3-epoxypropoxy) propyltrimethoxysilan, γ-Methacryloxypropyltrimethoxysilane, or N-(β-aminoethyl)-γ-aminopropylmethylbimethoxy silane.

4. The method of manufacturing conductive film according to claim 1, wherein the other conductive particle is nano-silver particle, micro-silver powder, polypyrrole particle or golden ball.

5. The method of manufacturing conductive film according to claim 1, wherein the curing agent is one or mixture of at least two of Methylhexahydrophthalic anhydride, phenyl-dimethylurea, triethylamine, 2-Ethyl-4-methylimidazole, 2-Ethyl-4-methyl-1H-imidazole-1-propanenitrile, 3-Aminopropyl-imidazole, or 1-Methylimidazole; and the organic solvent is one or mixed solvent of at least two of Acetonitrile, Acetone, Tetrahydrofuran, 1-Methyl-2-pyrrolidinone, water, Acetone, Ethanol, N,N-Dimethylformamide, dichloromethane, trichloromethane, propyl alcohol, isopropyl alcohol, or glycol.

6. The method of manufacturing conductive film according to claim 1, wherein the adhesive resin is epoxy resin, and the epoxy resin is one or mixture of at least two of Diglycidyl Ether of Bisphenol-A epoxy resin, bisphenol F epoxy resin, ethylene oxidic ester epoxy resin, aliphatic epoxy resin, or cycloaliphatic epoxy resin.

7. A conductive film, comprising a conductive particle, an adhesive resin and a curing agent; wherein the conductive particle is a functionalized graphene or a mixture of the functionalized graphene and other conductive particle; the other conductive particle is nano-silver particle, micro-silver powder, polypyrrole particle or golden ball.

8. The conductive film according to claim 7, wherein a method of producing the functionalized graphene comprises: step 1 for preparing a graphene oxide; step 2 for providing a functional reagent to reacting with the graphene oxide for producing the functionalized graphene; wherein the functionalized reagent is γ-Aminopropyl triethoxysilane, γ-(2,3-epoxypropoxy) propyltrimethoxysilan, γ-Methacryloxypropyltrimethoxysilane, or N-(β-aminoethyl)-γ-aminopropylmethylbimethoxy silane.

9. The conductive film according to claim 7, wherein the adhesive resin is epoxy resin, and the epoxy resin is one or mixture of at least two of Diglycidyl Ether of Bisphenol-A epoxy resin, bisphenol F epoxy resin, ethylene oxidic ester epoxy resin, aliphatic epoxy resin, or cycloaliphatic epoxy resin; the curing agent is one or mixture of at least two of Methylhexahydrophthalic anhydride, phenyl-dimethylurea, triethylamine, 2-Ethyl-4-methylimidazole, 2-Ethyl-4-methyl-1H-imidazole-1-propanenitrile, 3-Aminopropyl-imidazole, or 1-Methylimidazole.

10. The conductive film according to claim 7, wherein the epoxy resin used in the conductive film has an amount of 20 wt %˜90 wt % of the conductive film, the functionalized graphene used in the conductive film has an amount of 1 wt %˜30 wt % of the conductive film, the other particle used in the conductive film has an amount of 0˜30 wt % of the conductive film, and the curing agent used in the conductive film has an amount of 0.1 wt %˜10 wt % of the conductive film.

11. A conductive film, comprising a conductive particle, an adhesive resin and a curing agent; wherein the conductive particle is a functionalized graphene or a mixture of the functionalized graphene and other conductive particle; the other conductive particle is nano-silver particle, micro-silver powder, polypyrrole particle or golden ball;
wherein a method of producing the functionalized graphene comprises: step 1 for preparing a graphene oxide; step 2 for providing a functional reagent to reacting with the graphene oxide for producing the functionalized graphene; wherein the functionalized reagent is γ-Aminopropyl triethoxysilane, γ-(2,3-epoxypropoxy) propyltrimethoxysilan, γ-Methacryloxypropyltrimethoxysilane, or N-(β-aminoethyl)-γ-aminopropylmethylbimethoxy silane;
wherein the adhesive resin is epoxy resin, and the epoxy resin is one or mixture of at least two of Diglycidyl Ether of Bisphenol-A epoxy resin, bisphenol F epoxy resin, ethylene oxidic ester epoxy resin, aliphatic epoxy resin, or cycloaliphatic epoxy resin; the curing agent is one or mixture of at least two of Methylhexahydrophthalic anhydride, phenyl-dimethylurea, triethylamine, 2-Ethyl-4-methylimidazole, 2-Ethyl-4-methyl-1H-imidazole-1-propanenitrile, 3-Aminopropyl-imidazole, or 1-Methylimidazole;
wherein the epoxy resin used in the conductive film has an amount of 20 wt %˜90 wt % of the conductive film, the functionalized graphene used in the conductive film has an amount of 1 wt %˜30 wt % of the conductive film, the other particle used in the conductive film has an amount of 0˜30 wt % of the conductive film, and the curing agent used in the conductive film has an amount of 0.1 wt %˜10 wt % of the conductive film.
